(19) United States
(12) Patent Application Publication
(10) Pub. No.: US 2001/0019603 A1
(43) Pub. Date: Sep. 6, 2001

(54) Timed schedule reminder via telephone

(75) Inventor: John McMahon, Ottawa (CA)

Correspondence Address: James W. McKee, Fay, Sharpe, Beall, Fagan, Minnich & McKee, LLP, 1100 Superior Avenue, 7th Floor, Cleveland, OH, 44114-2518, US

(73) Assignee: Mitel Knowledge Corporation

(21) Appl. No.: 09/799,274

(22) Filed: Mar. 5, 2001

(30) Foreign Application Priority Data
Mar. 6, 2000 (GB) 0005365.2

(51) Int. Cl. H04M 1/64

(52) U.S. Cl. 379/67.1

(57) ABSTRACT

A call server for providing reminders to a user via a telephone, comprising a call control software agent for receiving a reminder message and time from the user, and a schedule reminder application for contacting the user via the user's telephone at the scheduled time and then playing the reminder message. Activation of the reminder system may take place either at the user's telephone or desktop computer. According to an aspect of the invention, if the user does not answer the telephone reminder, the schedule reminder application initiates additional calls via the call control agent to secondary numbers and devices such as cellular phones, pagers, home telephone numbers.

### FIELD OF THE INVENTION

The present invention relates in general to voice mail systems and more particularly to a system for activating a timed schedule reminder from either a telephone or user desktop to automatically remind the user via telephone of an appointment or task

### BACKGROUND OF THE INVENTION

Prior to the advent of computers, one of the most popular tools for organizing one's appointments and schedules was through the use of a personal organizer (e.g. Daytimer® personal organizer system). One disadvantage of prior art paper-based scheduling systems is that there is no provision for “automatic” reminders of upcoming tasks or appointments.

With the introduction of desktop, laptop and, more recently, palmtop computers, software-based calendar reminder systems have gained a foothold in the market traditionally occupied by paper-based personal organizers. Software-implemented scheduling applications normally employ a reminder feature by which a window is generated on a graphical user interface (often along with audio alerting) to notify a user of an upcoming task or appointment. One disadvantage of software-implemented scheduling systems is that the user must be in the vicinity of his/her computer in order to receive the reminder.

### SUMMARY OF THE INVENTION

According to the present invention, a computer-based scheduling system is provided which permits the user to record personal messages via voice, and then remind the user of important tasks or appointments by calling the user via telephone (cellular phone or pager, etc.) and playing back the user's own recorded reminder message. The time for the reminder is set by the user. When the time for the reminder occurs, the user's phone rings. Upon going off-hook, the user receives the voice message previously stored.

According to one aspect of the invention, the user's message may be entered as a text message in an existing desktop calendar application, whereupon the text message is converted from text-to-voice using a speech engine for playback to the user via the user's phone.

According to another aspect of the invention, if the user fails to answer the telephone call, the system may be programmed to call secondary numbers (e.g. pager, home telephone number, etc.) in an effort to locate the user.

### BRIEF DESCRIPTION OF THE DRAWINGS

A detailed description of two embodiments of the invention is provided herein below, with reference to the following drawings, in which

FIG. 1 is a block diagram showing a configuration of the phone-activated configuration of the timed scheduled reminder according to a first embodiment of the invention;

FIG. 2 is a block diagram of a desktop-activated configuration of the time schedule reminder according to a second embodiment of the invention;

FIG. 3 is a message sequence diagram showing the scheduling of a reminder according to the timed scheduled reminder system of FIG. 1; and

FIG. 4 is a message sequence diagram showing activation of a scheduled reminder when the reminder has been scheduled via the desktop-activated configuration of FIG. 2.

### DETAILED DESCRIPTION OF THE PREFERRED EMBODIMENT

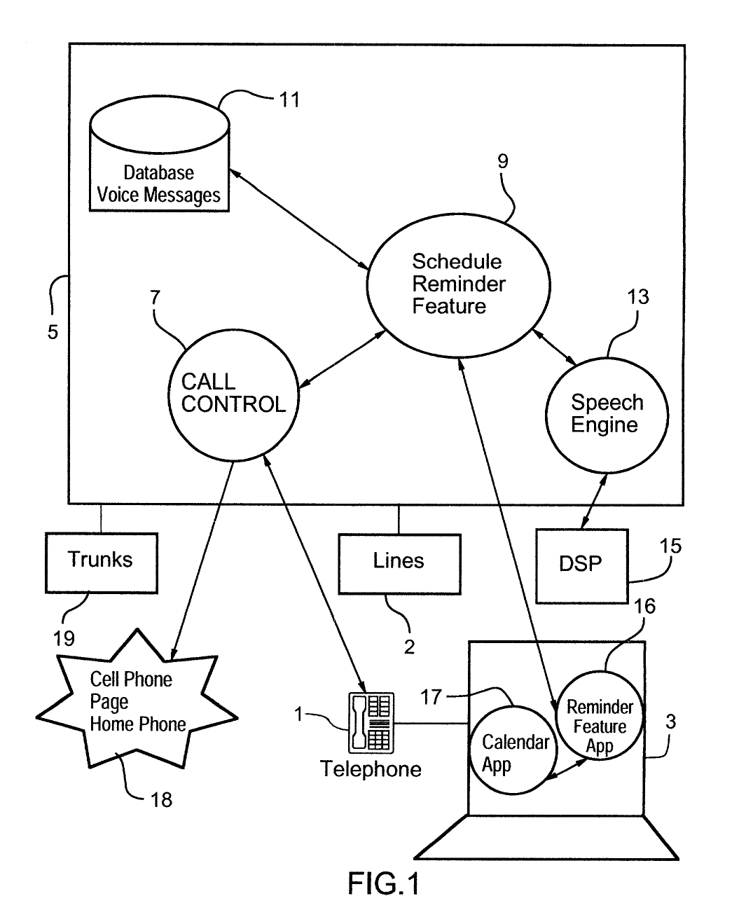

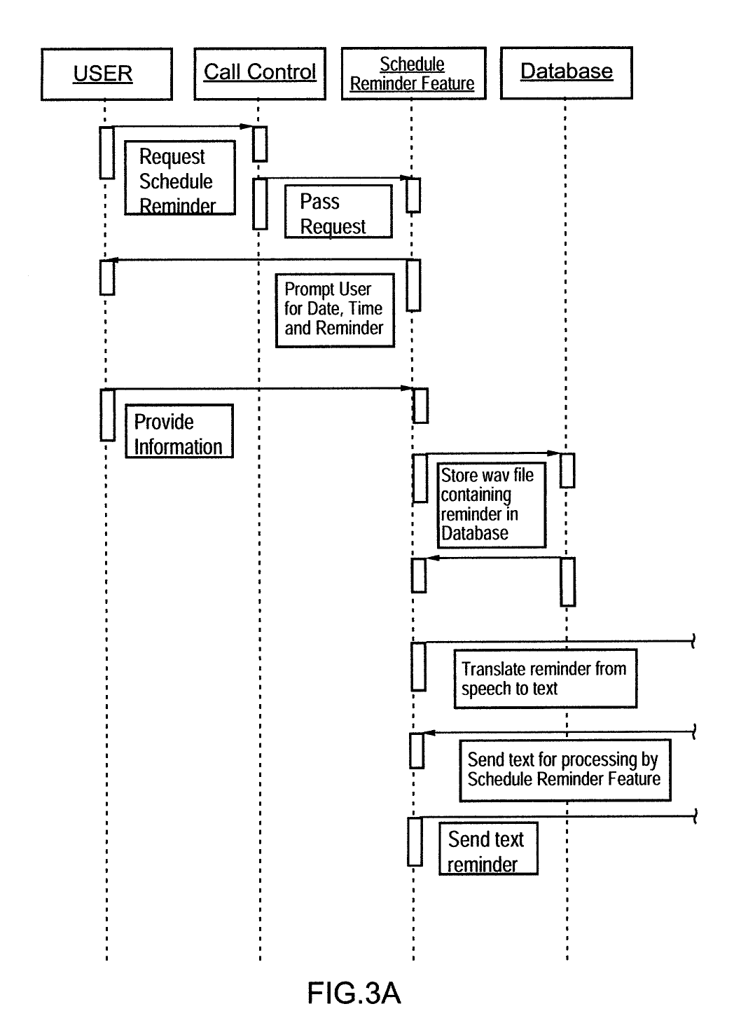

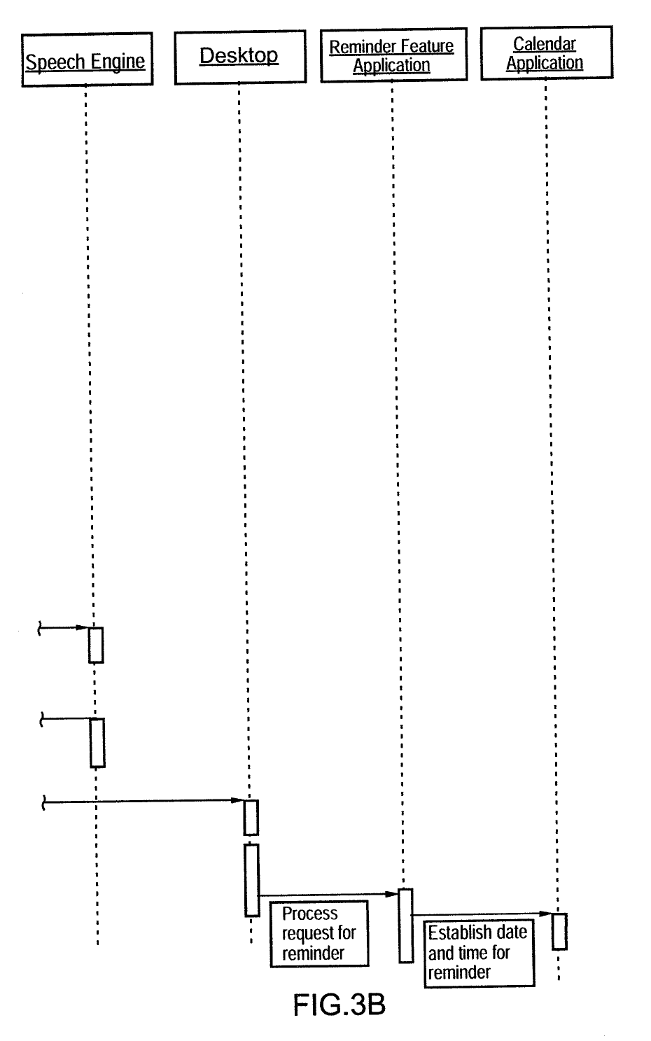

According to the embodiment of FIGS. 1 and 3, a user who wishes to activate a reminder goes off-hook via a phone 1, which can be either a plain old telephone set (POTS) or a phone application implemented at the user's desktop computer 3. In response to activating the reminder feature (e.g. via entering predetermined keystrokes to the phone 1 or activating an icon on the desktop phone application), the phone 1 sends a request to call control 7 within a call server 5. The phone 1 is connected to call server 5 via line circuits 2, in the conventional manner. The design and operation of the desktop phone application running on desktop computer 3 and the call server 5, are known in the art and will not be described in any further detail than is required for a proper understanding of the present invention. One suitable implementation of a desktop phone application may be found in Canadian Patent No. 2,158,408, and a description of a suitable call server may be found in U.S. Pat. No. 5,657,446. Call control 7 activates the schedule reminder feature 9 in response to which telephone voice prompts are provided to the user for inputting the desired time for the reminder. The system also prompts the user to record a reminder message, if desired. Any recorded voice message is saved as a .WAV file and stored in a database 11 for later playback. The user's recorded voice message is also sent to a speech engine 13 where it is converted to a text file via a DSP 15, and returned to the user's desktop 3. Examples of suitable speech engines include the Microsoft Speech Recognition Engine as set forth in www.microsoft.com/IIT/mscsr.htrm, and the Livent Automatic Speech Recognition Engine as set forth in www.lvcent.com/ideas2/lscip/descr.htm.

The reminder feature application 16 passes the text file to the Calendar application and inputs that information into appropriate text fields for the specified date and time.

One example of an appropriate calendar application 17 is Microsoft Outlook®. The reminder feature application 9 communicates with the calendar application 17 and passes to it the text files necessary for the calendar application to insert the text information, provided by the user, into the appropriate calendar text fields. For example, a meeting can be scheduled for a specific day and time. The user indicates the date and time for the reminder when prompted by the schedule reminder application 9, and records an appropriate reminder message. This information is passed from the schedule reminder feature 9 to the reminder feature application 16. The information is then passed to the user's calendar application 17 and inserted into the requested day and time so that the information becomes available for viewing by the user in his/her calendar application.

When the time occurs for the reminder, call control 7 is notified by the schedule reminder feature 9 and the user is called at his/her phone 1 (not shown in FIG. 3). In response to the user going off-hook, call control 7 detects voice on the phone line (e.g. the user answers the telephone with “Hello”), and then plays the message stored in database 11.

If the user does not answer the call, the schedule reminder feature 9 reviews any secondary numbers that the user may have entered. If there are secondary numbers, call control 7 calls the secondary numbers, represented in FIG. 1 by reference 18, which may be cellular phones, pagers, home phones, etc. The primary or secondary calls may be placed through appropriate lines 2 or trunks 19 of the call server 5, in a well-known manner. If no secondary numbers have been provided, the schedule reminder feature 9 attempts to contact the user again at the primary number. The number of times that the user is called back and the length of time between reminders may be preset by the user when initially setting up the reminder. Default times may be programmed in order to avoid indefinite repeat of the reminder.

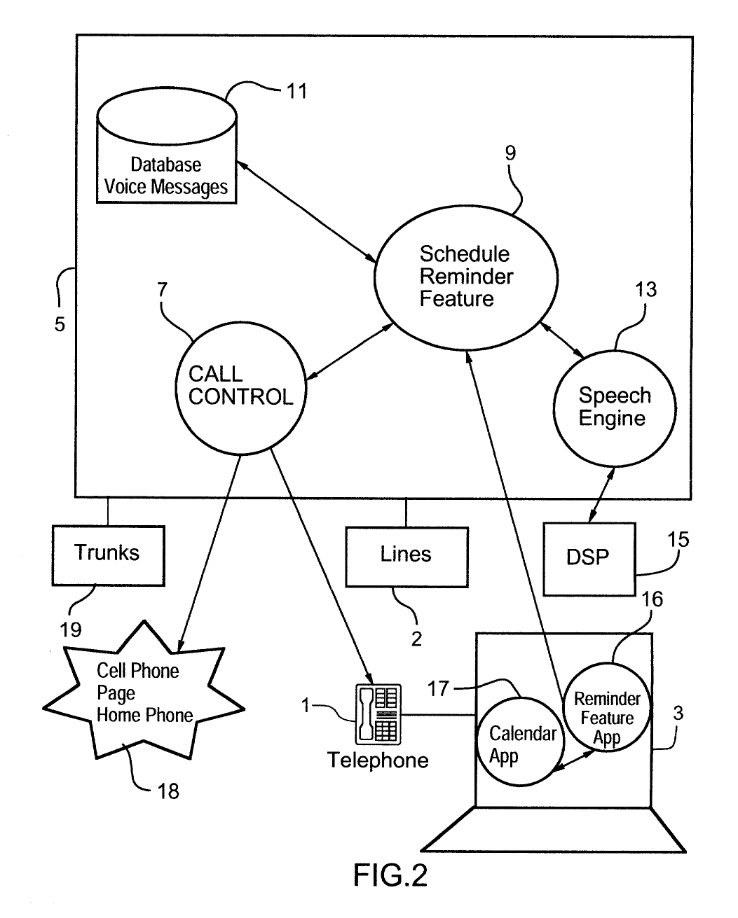

According to the alternative embodiment of FIG. 2, the time schedule reminder 9 may be activated directly via the desktop 3 rather than via the user's phone 1. In this embodiment, the user accesses his/her calendar application 17 (e.g. Microsoft Outlook®) and enters a reminder message in the calendar for a specific date and time. The schedule reminder feature application 16 sends the text file to call control 7 which in turn passes the information to the main schedule reminder feature application 9 within call server 5. The schedule reminder feature 9 receives the text file sent from the reminder feature application 16 and stores the user's request in the database 11 according to the date and time indicated by the text file passed by the reminder feature application 16. The text reminder is then sent to the speech engine 13 for translation into a voice file. Once translated, the speech engine 13 passes the voice file back to the schedule reminder feature 9. The .WAV voice file is stored in the database 13 and indexed to the appropriate date and time for the reminder for that particular user. The schedule reminder feature 9 checks the database 13 once every minute in order to determine if it must send out a reminder to a particular user based on the stored date and time. Date and time are determined by the internal time clock provided with the call servers. Once the desired date and time occurs, the schedule reminder feature 9 removes the voice message from the database 13 and sends it through call control 7 to the specified destination. The destination is determined by the user's settings for the reminder feature application 16. Once the message has been sent out and received, the information is removed from the database 13 for cleanup and maintenance purposes. The speech engine 13 utilizes DSP 15 to convert the text to voice messages. The voice messages are sent back to the schedule reminder feature 9 for storage in database 11.

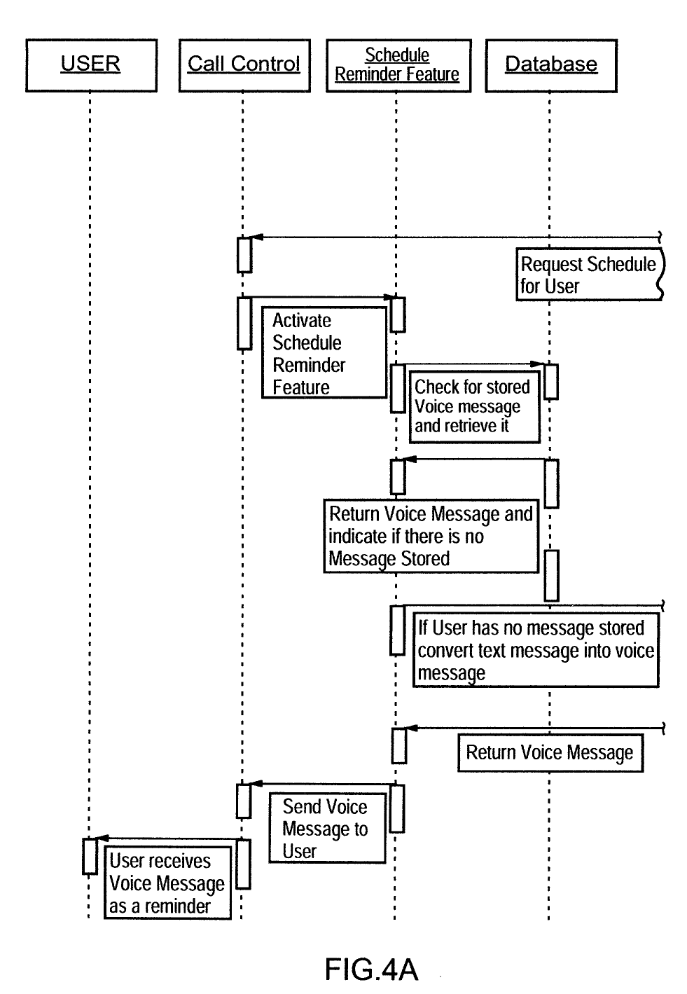

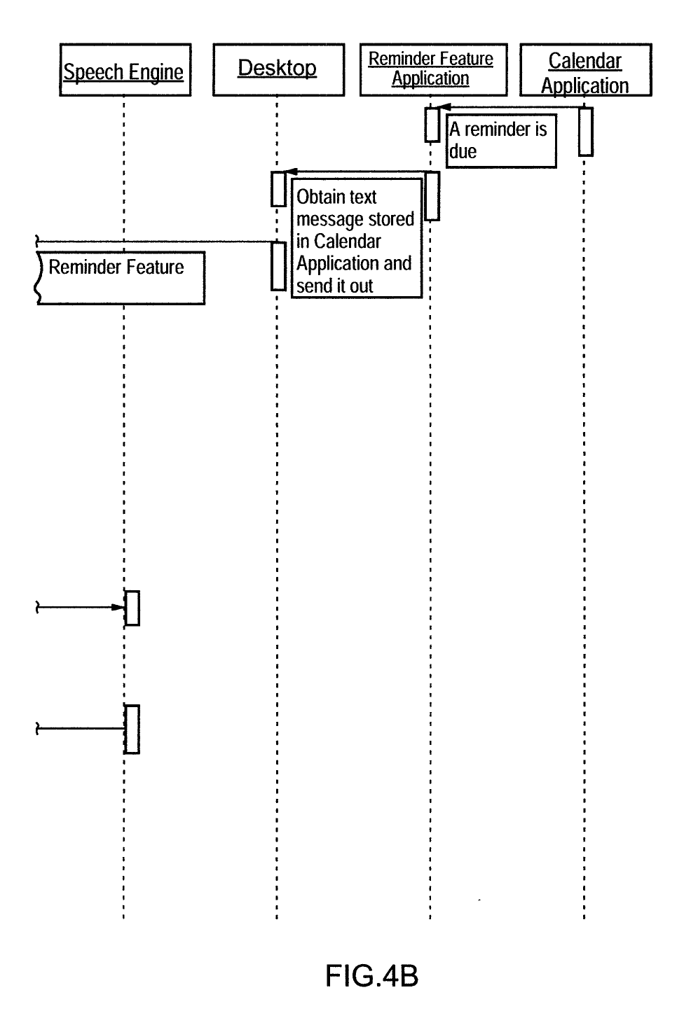

When the appropriate date and time occurs, the schedule reminder feature 9 passes the converted text message to call control 7 whereupon the user's phone 1 is called, as shown in FIG. 4. The same sequence as discussed above with reference to FIG. 1 is then followed concerning the caller going off-hook, being played the message, and call control 7 reverting to secondary numbers when the first number is not answered.

Alternatives and variations of the invention are possible. All such applications are believed to be within the sphere and scope of the claims appended hereto.

What is claimed is:

1. A call server for providing reminders to a user via a communication device under control of said call server, comprising:
call control means for receiving from said user a reminder message and a time to provide said reminder message to said user; and
schedule reminder means for contacting said user via said communication device at said time and providing said reminder message.

2. The call server of claim 1, further comprising at least one secondary communication device for contacting said user.

3. The call server of claim 1 further comprising conversion means for converting said reminder message between audio and text formats.

4. The call server of claim 1, wherein said communication device is a phone.

5. The call server of claim 2, wherein said at least one secondary communication device is selected from the group consisting of pager, cellular telephone and additional phone.

6. The call server of claim 1, further including a telephone for user entry of said reminder message by voice and said time via a keypad of said telephone.

7. The call server of claim 1, further including a database for storing said time and for storing said reminder message in audio format as a wave file.

8. The call server of claim 1, further including a desktop calendar application for user entry of said reminder message and said time.

9. The call server of claim 6, further comprising a speech engine for converting said reminder message to text format.

10. The call server of claim 9, further including a desktop calendar application for receiving and storing said reminder message in text format and said time.
